(19) United States
(12) Patent Application Publication
(10) Pub. No.: US 2022/0254157 A1
(43) Pub. Date: Aug. 11, 2022

(54) Video 2D Multi-Person Pose Estimation Using Multi-Frame Refinement and Optimization

(71) Applicant: Northeastern University, Boston, MA (US)

(72) Inventors: Yun Fu, Brookline, MA (US); Songyao Jiang, Everett, MA (US)

(21) Appl. No.: 17/594,881

(22) PCT Filed: May 13, 2020
(86) PCT No.: PCT/US2020/032595

§ 371 Date: Nov. 2, 2021

Related U.S. Application Data
(60) Provisional application No. 62/848,358, filed on May 15, 2019.

(51) Int. Cl. G06V 20/40; G06V 20/64; G06V 10/82; G06T 7/246; G06T 7/70; G06N 3/08; G06N 3/04

(52) U.S. Cl. CPC G06V 20/40; G06V 20/64; G06V 10/82; G06N 3/0454; G06T 7/70; G06N 3/084; G06T 7/248

(57) ABSTRACT

Embodiments provide functionality for identifying joints and limbs in frames of video that use indications of joints and limbs from a previous frame. One such embodiment processes a current frame of video to determine initial predictions of joint and limb locations in the current frame. In turn, indications of the joint and limb locations in the current frame are generated by refining the initial predictions of the joint and limb locations based on indications of respective joint and limb locations from a previous frame. Embodiments provide results that are insensitive to occlusions and results that have less shaking and vibration.

### RELATED APPLICATION

This application claims the benefit of U.S. Provisional Application No. 62/848,358, filed on May 15, 2019. The entire teachings of the above application are incorporated herein by reference.

### BACKGROUND

Pose estimation, i.e., locating body parts in images, has been a computer vision task of increasing importance. Similarly, locating body parts in video, and locating body parts for multiple people in video, has become increasingly desired.

### SUMMARY

While techniques exist for pose estimation and multi-person pose estimation in video, existing methods are inadequate. Many existing methods combine two separate models. These existing methods do pose estimation on each frame, track the estimated results, and, then, after performing the pose estimation, correct the results using temporal information contained in videos. This makes existing methods computationally complicated and limits the running speed of the existing methods.

Embodiments provide a novel deep learning model particularly designed and optimized for video pose estimation, which inherently takes a pose estimation result of previous frames as input to refine a new pose estimation of a current frame. Embodiments track estimated poses and make a model, i.e., a trained neural network, insensitive to occlusions. Moreover, embodiments of present invention apply a backward reconstruction loop and temporal consistency to an objective function to alleviate inconsistent estimation between adjacent frames. This significantly mitigates shaking and vibration phenomena of estimated pose skeletons in video pose estimation.

An example embodiment is directed to a method of identifying joints and limbs in a current frame of video. Such an example embodiment, first, processes the current frame of video to determine initial predictions of joint and limb locations in the current frame. In turn, indications of the joint and limb locations in the current frame are generated by refining the initial predictions of the joint and limb locations based on indications of respective joint and limb locations from a previous frame.

Another embodiment generates an indication of pose for at least one object based upon the indications of the joint and limb locations in the current frame. Embodiments may be used to identify limbs and joints of any type of object. For example, in an embodiment, the indications of the joint and limb locations in the current frame correspond to joints and limbs of at least one of: a human, animal, machine, and robot, amongst other examples. According to an embodiment, the indication of joint locations in the current frame indicates a probability of a joint at each location in the current frame and the indication of limb locations in the current frame indicates a probability of a limb at each location in the current frame. In an example embodiment, the previous frame is adjacent in time to the current frame in the video.

In an embodiment, generating the indications of the joint and limb locations in the current frame comprises processing the initial prediction of joint locations in the current frame and the indications of joint locations from the previous frame with a first deep convolutional neural network to generate the indication of joint locations in the current frame. Further, in such an embodiment, an initial prediction of limb locations in the current frame and the indications of limb locations from the previous frame are processed with a second deep convolutional neural network to generate the indication of limb locations in the current frame.

Another embodiment processes the current frame of video to determine an initial prediction of limb orientation at each initial prediction of limb location in the current frame. Further, such an embodiment generates an indication of limb orientation in the current frame by refining the initial prediction of limb orientation at each initial prediction of limb location in the current frame using indications of limb orientations from the previous frame.

Another embodiment is directed to a computer system for identifying joints and limbs in a current frame of video. The computer system includes a processor and a memory with computer code instructions stored thereon. In such an embodiment, the processor and the memory, with the computer code instructions, are configured to cause the system to identify joints and limbs according to any embodiment described herein.

Yet another embodiment is directed to a computer program product for identifying joints and limbs in a current frame of video. The computer program product comprises one or more non-transitory computer-readable storage devices and program instructions stored on at least one of the one or more storage devices. The program instructions, when loaded and executed by a processor, cause an apparatus associated with the processor to identify joints and limbs in a frame of video as described herein.

An embodiment is directed to a method of training a neural network to identify joints and limbs in a current frame of video. Such a method embodiment performs forward and backward optimization between adjacent frames of video to refine joint location prediction results and limb location prediction results of a neural network. In turn, the neural network is updated based on the refined joint location prediction results and the refined limb location prediction results.

According to an embodiment, performing the forward optimization comprises calculating a loss between (i) joint location prediction results and limb location prediction results generated by the neural network for a frame of video and (ii) a ground truth indication of joint locations and limb locations in the frame of video. Further, according to an embodiment, performing the backward optimization comprises processing, with the neural network, (i) joint location prediction results generated by the neural network for a frame of video, (ii) limb location prediction results generated by the neural network for the frame of video, and (iii) a previous frame to determine an indication of joint locations and an indication of limb locations for the previous frame. Such an embodiment calculates a loss between (i) the determined indication of joint locations and the determined indication of limb locations for the previous frame and (ii) a ground truth indication of joint locations and limb locations for the previous frame.

In yet another embodiment, performing forward and backward optimization between adjacent frames of video to refine joint location prediction results and limb location prediction results of the neural network comprises calculating a temporal consistency loss by calculating a loss between (i) joint location prediction results and limb location prediction results of the neural network for a first frame and (ii) joint location prediction results and limb location prediction results of the neural network for a second frame, wherein the second frame is adjacent to the first frame.

It is noted that embodiments of the method, system, and computer program product may be configured to implement any embodiments described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a simplified diagram of a system to identify joints and limbs according to an embodiment.

FIG. 2 is a flow diagram of a method for identifying joints and limbs in a frame of video according to an embodiment.

FIG. 3 is a block diagram of a framework for identifying joints and limbs in an embodiment.

FIG. 4 is a block diagram of a framework during a training phase according to an embodiment.

FIG. 5 is a block diagram of a system embodiment for identifying joints and limbs for a first frame of video.

FIG. 6 is a block diagram of a system embodiment for identifying joints and limbs using identification results from a previous frame.

FIG. 7 is a simplified block diagram of a computer system for identifying joints and limbs in a frame of video according to an embodiment.

FIG. 8 is a simplified diagram of a computer network environment in which an embodiment of the present invention may be implemented.

### DETAILED DESCRIPTION

A description of example embodiments follows.

Pose estimation, which includes identifying joints and limbs in images and video, aims to estimate multiple poses of people or other such target objects in a frame of video and has been a long studied topic in computer vision [1, 6, 14, 9, 3] (bracketed numbers in this document refer to the enumerated list of references hereinbelow). Previous methods for human pose estimation utilized pictorial structures [1] or graphical models [3]. Recently, with the development and application of deep learning models, attempts to utilize deep convolutional neural networks to do 2D multi-person pose estimation have been made. These attempts can be categorized into two major categories, top-down methods and bottom-up methods.

Top-down methods detect persons by first using a person detector and then using single person pose estimation to get poses for all persons. He et al. [7] extended the Mask-RCNN framework to human pose estimation by predicting a one-hot mask for each body part. Papandreou et al. [11] utilized a Faster RCNN detector to predict person boxes and applied ResNet in a fully convolutional fashion to predict heatmaps for every body part. Fang et al. [5] designed a symmetric spatial transformer network to alleviate the inaccurate bounding box problem.

The existing top-down methods always utilize a separately trained person detector to first detect people in the image. With the knowledge of the detected people, i.e., bounding boxes of detected persons, top-down methods then do single-person keypoint estimation within each bounding box [7, 11, 5]. The problem with top-down methods is that if the person detection fails, the following keypoint estimation will also fail. Further, using two models, e.g., neural networks, in the top-down methods, also makes the top-down methods slower and makes utilizing top-down methods for real-time applications difficult.

Bottom-up methods do not utilize person detectors. Instead, bottom-up methods try to detect all of the body joints from the whole image and, then, associate those joints to each person to form their skeletons [12, 2, 10]. In general, bottom-up methods are less accurate compared to top-down methods. However, bottom-up methods can run faster than top-down methods in multi-person pose estimation. The inference time of bottom-up methods is less linear to the number of persons in the image.

Bottom-up methods detect body parts first and then associate body parts into persons. Insafutdinov et al. [12] proposed using an Inter Linear Program method to solve the body part association problem. Cao et al. [2] introduced Part Affinity Fields to predict the direction and activations for each limb to help associate body parts. Newell et al. [10] utilized predicted pixel-wise embeddings to assign detected body parts into different groups.

Video-based multi-person pose estimation often involves tracking methods as post processing. The post processing methods track the detected person across adjacent frames and then track the keypoints of that person to avoid detection failures caused by motion blur and occlusions. Those tracking methods cannot be applied to bottom-up methods because bottom-up methods do not provide any knowledge of a person in each frame. Tracking joints without knowing the movement of a person leads to unsatisfactory results. In video applications, bottom-up methods are applied on each frame, which leads to inconsistent pose estimation across adjacent frames. The inconsistency causes problems like shaking and jumping of keypoint detection.

Embodiments provide functionality for two-dimensional (2D) multi-person pose estimation in video. In embodiments, the pose estimation is formulated as detecting 2D keypoints, e.g., joints and limbs, and connecting the keypoints of the same person into skeletons. Embodiments provide a bottom-up method in multi-person pose estimation. Different from other methods, embodiments directly predict a confidence map for a human skeleton to associate the detected body parts.

Embodiments of the present invention provide a video-based state-of-the-art image-based bottom-up method for pose estimation that is specially optimized for video applications to solve the occluded and inconsistent detection between adjacent frames. To utilize the temporal information contained in the video and to avoid inconsistent detection across frames, embodiments use previous frames to refine the pose estimation result of the current frame. As such, embodiments track the poses across frames and use the determined results, e.g., pose, from a previous frame to refine the results for a current frame. By implementing this functionality, embodiments are resistant to pose occlusions. Moreover, embodiments build a backward path and reconstruct the previous pose estimation refined by the current estimation and minimize on the difference between the previous estimation and the reconstructed estimation. Assuming the movement between two adjacent frames is minor, an embodiment penalizes on the difference between the estimation on previous frame and the estimation on current frame to stabilize the pose estimation and alleviate any shaking and vibration on the predicted poses in the video.

Embodiments (1) utilize the pose estimation results of previous frames to refine the current frame results to track poses and handle occlusions (2) apply a backward loop to reconstruct the previous pose estimation from the current frames to minimize inconsistent detection and (3) penalize on the changes in detection between adjacent frames to avoid shaking and vibration in video pose estimation.

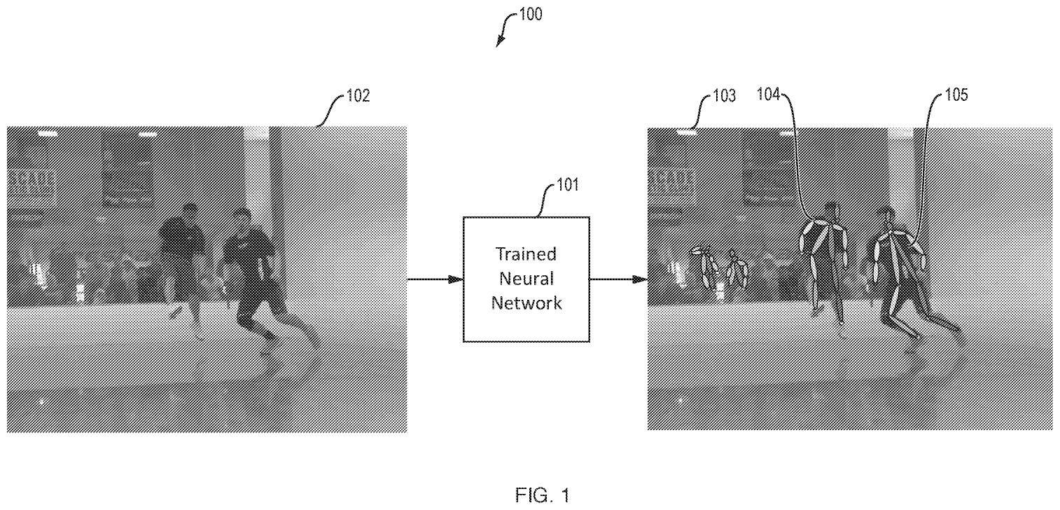

FIG. 1 illustrates a system 100 for identifying joints and limbs in a frame of video according to an embodiment. The system 100 includes the trained neural network 101. The neural network 101 is trained to identify joints and limbs in frame of video as described herein. In operation, the trained neural network 101 receives the frame 102 and processes the frame 102 to generate the indication 103 of joints, e.g., the joint 104, and limbs, e.g., the limb 105, in the frame 102. The trained neural network 101 may also generate the indication of joints and limbs 103 using an indication of joints and limbs that was determined for a frame prior in time to the frame 102.

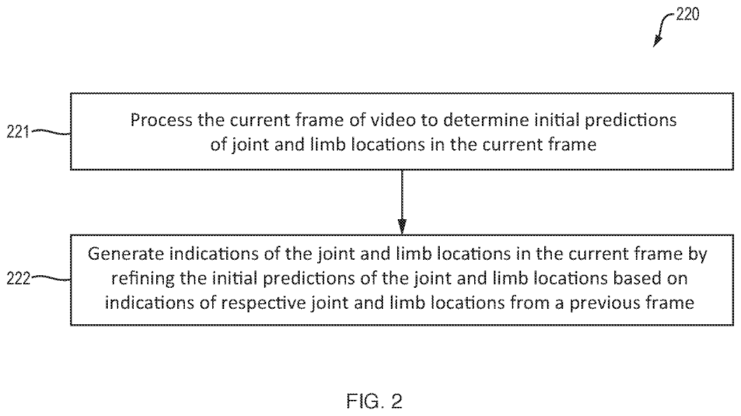

FIG. 2 is a flow diagram of a method 220 for identifying joints and limbs in a current frame of video. The method 220, processes 221 the current frame of video to determine initial predictions of joint and limb locations in the current frame. In turn, the method 220, generates 222 indications of the joint and limb locations in the current frame by refining the initial predictions of the joint and limb locations based on indications of respective joint and limb locations from a previous frame. According to an embodiment, the indication of joint locations in the current frame indicates a probability of a joint at each location in the current frame and the indication of limb locations in the current frame indicates a probability of a limb at each location in the current frame. According to an embodiment, locations are x-y coordinates in the image. Further, in an embodiment, the unit of the locations, e.g., coordinates, are in pixels. Moreover, in an example embodiment, the previous frame is adjacent in time to the current frame in the video.

An embodiment of the method 220 further comprises generating an indication of pose for at least one object based upon the indications of the joint and limb locations in the current frame generated 222 for the current frame.

Embodiments of the method 220 may be used to identify limbs and joints of any type of object. For example, in an embodiment, the indications of the joint and limb locations in the current frame correspond to joints and limbs of at least one of: a human, animal, machine, and robot, amongst other examples. Moreover, embodiments may identify limbs and joints for multiple objects, e.g., people, in a frame.

According to an embodiment of the method 220, generating the indications of the joint and limb locations in the current frame 222 includes processing the initial prediction of joint locations in the current frame and the indications of joint locations from the previous frame with a first deep convolutional neural network to generate the indication of joint locations in the current frame. Further, in such an embodiment, the initial prediction of limb locations in the current frame and the indications of limb locations from the previous frame are processed with a second deep convolutional neural network to generate the indication of limb locations in the current frame.

Another embodiment of the method 220 identifies orientation of the identified limbs. Such an embodiment processes the current frame of video to determine an initial prediction of limb orientation at each initial prediction of limb location in the current frame. In turn, an indication of limb orientation in the current frame is generated by refining the initial prediction of limb orientation at each initial prediction of limb location in the current frame using indications of limb orientations from the previous frame. As such, the determination of limb orientation for a current frame is refined using the limb orientation results from a previous frame.

Hereinbelow, a problem formulation for limb and joint identification is provided and a framework for identifying joints and limbs according to an embodiment is described. Additional components of embodiments including joint prediction, limb prediction, backward reconstruction, temporal consistency, neural network training, and applying the trained neural network for video pose estimation are also further elaborated upon.

Problem Formulation

Let Fᵢ be a frame sampled from a video sequence containing n frames {Fᵢ}₁ⁿ. Let P_{i,j}=(x_{i,j}, y_{i,j}) be the multi-person 2D pose keypoint coordinates of the jth person in the frame Fᵢ. Given {Fᵢ}₁^{k} frames, where 0<k≤n, which are the current frames and all the previous frames. In such an embodiment, the target is to estimate the current keypoints {P_{k,j}}ⱼ₌₁^{m} where m is the number of persons in the current frame. Moreover, in the embodiment, a deep convolutional neural network model G takes the current frame and the previous frame as input and does pose estimation, which can be described as {P_{k,j}}ⱼ₌₁^{m}=G(Fᵢ, Fᵢ₋₁).

An implemented in of the neural network follows an image-based 2D bottom-up pose estimation method [2] to estimate a joint heatmap Sᵢ and a limb heatmap Lᵢ and, then, associates the joint and limb heatmaps into keypoint results P_{i,j} using an association method denoted by M. Such an embodiment of the method can then be described by {Pₖⱼ}ⱼ₌₁^{m}=M(G(Fᵢ, Sᵢ₋₁, Lᵢ₋₁)).

Framework

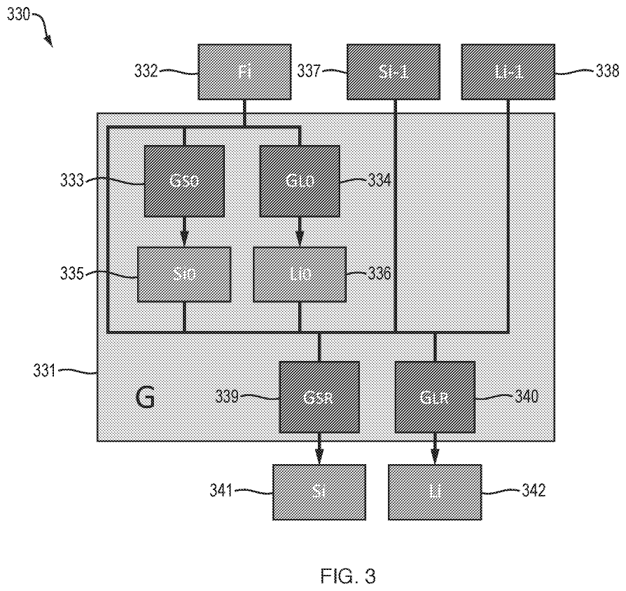

FIG. 3 illustrates a system framework 330 according to an embodiment. FIG. 3 illustrates the input, output, and the refinement process of the deep neural network model G 331. In FIG. 3, the variables 337 and 338 are from a previous frame, while the variables 332, 335, 336, 341, and 342 are for the current frame 332. F 332 is a frame sampled from a video. G_{S0} 333 and G_{L0} 334 are initial detection blocks, while G_{SR} 339 and G_{LR} 340 are refinement blocks for the joint heatmap S 335 and limb heatmap L 336.

In operation, G 331 takes the current frame 332 Fᵢ as input and does an initial estimation using the submodules 333 G_{S0} and 334 G_{L0} to determine a joint heatmap 335 Sᵢ₀ and limb heatmap 336 Lᵢ₀, respectively. In turn, the initial estimations 335 (joints) and 336 (limbs) are refined by the submodule 339 G_{SR} and submodule 340 G_{LR} using the previous results 337 Sᵢ₋₁ and 338 Lᵢ₋₁. The refining by the submodules 339 and 340 produces 341 Sᵢ and 342 Lᵢ, which are the joint heatmap 341 and limb heatmap 342 for the frame 332 Fₜᵢ. In the framework 330, 333 G_{S0}, 339 G_{SR}, 334 G_{L0}, and 340 G_{LR} are all deep convolutional neural networks. Further, in an embodiment, before inputting to 339 G_{SR} and 340 G_{LR}, 335 Sᵢ₀, 336 Lᵢ₀, 337 Sᵢ₋₁, 338 Lᵢ₋₁ are concatenated together in channel dimension.

Joint Heatmap Prediction

In the joint heatmap prediction, the proposed framework, e.g., the framework 330, generates a confidence map, e.g., 341, which is the probability of joints appearing at each location of the input image, e.g., the frame 332. For an input image of size H×W×3, the corresponding joint heatmap S will be of size H×W×p, where H and W are the height and width of the input image, and p is the number of joints.

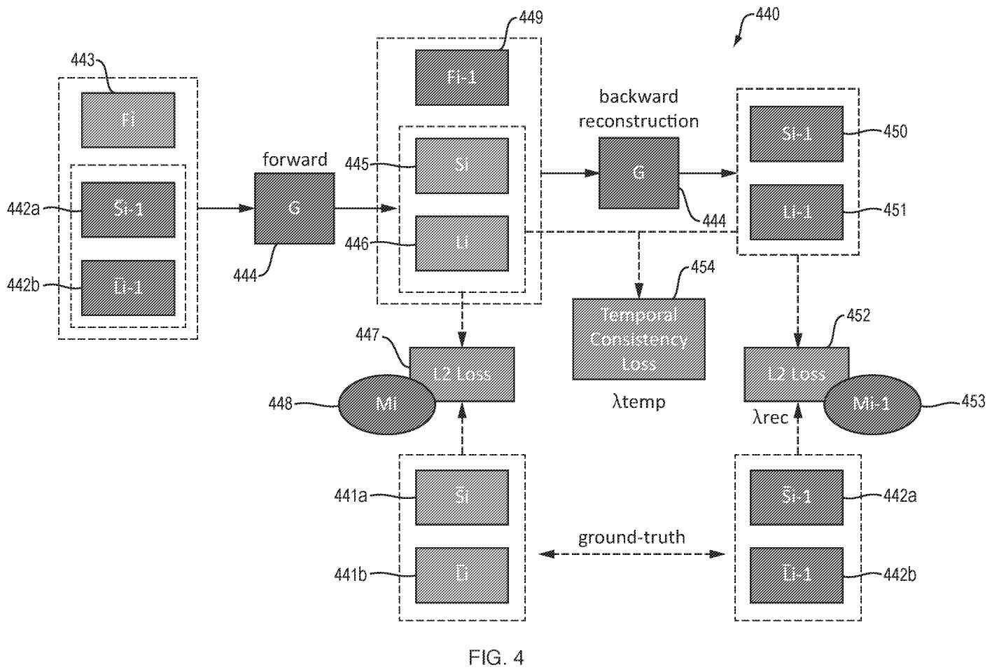

To prepare a ground-truth heatmap prediction, e.g., the ground-truth predictions 441a and 442a discussed hereinbelow in relation to FIG. 4, an embodiment puts a gaussian response at each location of the same joints in the corresponding channel of the joint heatmap. The overlapping area of the same type of joints is handled by a maximum operation. The method to construct the ground-truth heatmap can be represented by equation (1) below:

$${\overline{S}}_{i} ( x , y , c ) = {max}_{1 \leq j \leq m} ( {e}^{- \frac{{‖ ( x , y ) - {P}_{i j}^{l} ‖}_{2}^{2}}{{σ}^{2}}} ) \qquad ( 1 )$$

where P_{i,j}^{l} is the keypoints of the l-th joint of the j-th person in the i-th frame, and a is the standard deviation of the Gaussion distribution.

An embodiment employs the idea of intermediate supervision such that the joint heatmap prediction output from G_{S0} and G_{SR} are compared with the ground-truth heatmap using a L2 loss function, which can be expressed as follows:

$${ℒ}_{S} = {‖ {G}_{S 0} ( {F}_{i} ) - {\overline{S}}_{i} ‖}_{2} + {‖ {G}_{S R} ( {G}_{S 0} ( {F}_{i} ) , {\overline{S}}_{i - 1} , {\overline{L}}_{i - 1} ) - {\overline{S}}_{i} ‖}_{2} \qquad ( 2 )$$

In an embodiment, when minimizing the above joint prediction loss, the submodule G_{S0} and G_{SR} are trained to output the confidence map of the joint predictions for given images, i.e., frames.

Limb Prediction

For limb prediction, an embodiment predicts a vector field indicating the position and orientation of limbs in given frames. The prediction can also be seen as a confidence map with size H×W×2q, where q is the number of limbs defined. To prepare the ground-truth confidence map for limb prediction, e.g., the ground truth predictions 441b and 442b discussed hereinbelow in relation to FIG. 4, an embodiment first defines q limbs between a pair of joints indicating meaningful human limbs (or limbs of any object being detected) such as head, neck, body, trunk and forearm, which will form a skeleton of a human body in the pose association part. Then, such an embodiment fills the region between those pairs of joints using a normalized vector pointing to the direction of those limbs. The limb region is defined as the points within distance of the line segment between a pair of joints. Numerically, such an embodiment defines the distance d from a point (x, y) to a limb segment of a pair of joints ((xₗ_{₁}, yₗ_{₁}), (xₗ_{₂}, yₗ_{₂})) as:

$$d = \frac{\vert ( {y}_{{l}_{1}} - {y}_{{l}_{2}} ) x + ( {x}_{{l}_{2}} - {x}_{{l}_{1}} ) y + ( {y}_{{l}_{1}} {x}_{{l}_{1}} - {y}_{{l}_{1}} {x}_{{l}_{2}} - {y}_{{l}_{2}} {x}_{{l}_{1}} + {y}_{{l}_{2}} {x}_{{l}_{2}} ) \vert}{\sqrt{{( {y}_{{l}_{1}} - {y}_{{l}_{2}} )}^{2} + {( {x}_{{l}_{2}} - {x}_{{l}_{1}} )}^{2}}} \qquad ( 3 )$$

The limb region comprises all the points in a rectangle where their distance d from the given limb is within a threshold θ, which represents half the width of the limb. Within the limb region, an embodiment fills each location in the limb region with the normalized vector of the limb denoted as:

$$\frac{{p}_{{l}_{1}} - {p}_{{l}_{2}}}{{‖ {p}_{{l}_{1}} - {p}_{{l}_{2}} ‖}_{2}} \qquad ( 4 )$$

Similar to joint prediction, an embodiment calculates a L2 loss between the predicted limb locations Lᵢ and the ground-truth limb locations L̅ᵢ as the objective function when training the framework. An embodiment sums up both the losses between intermediate prediction and refined prediction as the limb loss, which can be represented by:

$${ℒ}_{L} = {‖ {G}_{L 0} ( {F}_{i} ) - {\overline{L}}_{i} ‖}_{2} + {‖ {G}_{L R} ( {G}_{L 0} ( {F}_{i} ) , {S}_{i - 1} , {L}_{i - 1} ) - {\overline{L}}_{i} ‖}_{2} \qquad ( 5 )$$

Backward Reconstruction

Embodiments introduce a backward loop to reconstruct the joint heatmap and limb heatmap from the prediction in the current frame to increase the accuracy and robustness of inter-frame prediction. In detail, one such example embodiment inputs the current prediction and the previous frame to the neural network and predicts the joint heatmap and limb map of the previous frame. Then, such an embodiment compares the prediction with the ground-truth and calculates reconstruction losses of the joint heatmap and limb heatmap which can be expressed as follows:

$$\begin{matrix}{ℒ}_{Srec} = ‖ {G}_{S R} ( {G}_{S 0} ( {F}_{i - 1} ) , {G}_{SR} ( {G}_{S 0} ( {F}_{i} ) , {\overline{S}}_{i - 1} , {\overline{L}}_{i - 1} ) , {G}_{LR} ( {G}_{L 0} ( {F}_{i} ) , {\overline{S}}_{i - 1} , {\overline{L}}_{i - 1} ) ) - {{\overline{L}}_{i} ‖}_{2} & ( 6 ) \\ {ℒ}_{Lrec} = ‖ {G}_{LR} ( {G}_{L 0} ( {F}_{i - 1} ) , {G}_{SR} ( {G}_{S 0} ( {F}_{i} ) , {\overline{S}}_{i - 1} , {\overline{L}}_{i - 1} ) , {G}_{LR} ( {G}_{L 0} ( {F}_{i} ) , {\overline{S}}_{i - 1} , {\overline{L}}_{i - 1} ) ) - {{\overline{L}}_{i} ‖}_{2} & ( 7 )\end{matrix}$$

Temporal Consistency

To mitigate the shaking and vibration due to inconsistent detection between adjacent frames, an embodiment penalizes on the difference between two predictions generated for adjacent frames assuming that the frame rate is fast enough which indicates that the inter-frame movement is relatively small. Such an embodiment introduces temporal consistency loss which is the L2 loss between the predictions of adjacent frames, using the following equations:

$$\begin{matrix}{ℒ}_{S t e m p} = {‖ {G}_{S R} ( {G}_{S 0} ( {F}_{i} ) , {\overline{S}}_{i - 1} , {\overline{L}}_{i - 1} ) - {G}_{S R} ( {G}_{S 0} ( {F}_{i - 1} ) , {\overline{S}}_{i} , {\overline{L}}_{i} ) ‖}_{2} & ( 8 ) \\ {ℒ}_{Ltemp} = {‖ {G}_{L R} ( {G}_{L 0} ( {F}_{i} ) , {\overline{S}}_{i - 1} , {\overline{L}}_{i - 1} ) - {G}_{L R} ( {G}_{L 0} ( {F}_{i - 1} ) , {\overline{S}}_{i} , {\overline{L}}_{i} ) ‖}_{2} & ( 9 )\end{matrix}$$

By minimizing the temporal consistency loss, such an embodiment minimizes the difference between two adjacent frames and obtains a stable prediction with minimum shaking and vibration.

FIG. 4 is a block diagram of a framework 440 during a training phase where a neural network of the framework 444 is trained to identify joints and limbs in a frame of video. The training in the framework 440 includes performing forward and backward optimization between adjacent frames of video to refine joint location prediction results and limb location prediction results of the neural network 444 and updating the neural network 444 based on the refined joint location prediction results and the refined limb location prediction results.

To perform the forward optimization, a current frame 443 and a ground truth indication of joint location 442a and a ground truth indication of limb location 442b, for a frame prior to the frame 443 (e.g., the frame 449) are processed by the neural network 444 to determine the indication of joint location 445 and limb location 446 for the frame 443. In turn, the loss 447 between (i) the joint location prediction results 445 and limb location prediction results 446 generated by the neural network 444 for the frame of video 443 and (ii) a ground truth indication of joint locations 441a and limb locations 441b in the frame of video 443 is calculated. Further, the loss 447 may be calculated with the binary mask 448 which masks out unlabeled regions in the frame 443. According to an embodiment, in the dataset (e.g., a dataset used to train the neural network 444), not every single person has a label. As such, embodiments may output joint and limb predictions of unlabeled persons in the video. However, those predictions do not have any ground-truth label to calculate losses. Thus, embodiments may use masks 448 and 453 to mask out those unlabeled persons. The masks 448 and 453 serve to disable those unlabeled areas when calculating the losses According to an embodiment, the loss 447 is calculated as described hereinabove in relation to equations 2 and 5.

To perform the backward optimization in the framework 440, the neural network 444 processes (i) joint location prediction results 445 generated by the neural network 444 for the frame of video 443, (ii) limb location prediction results 446 generated by the neural network 444 for the frame of video 443, and (iii) a previous frame 449, to determine an indication of joint locations 450 and an indication of limb locations 451 for the previous frame 449. Then, the loss 452 is calculated. The loss 452 is the loss between (i) the determined indication of joint locations 450 and the determined indication of limb locations 451 for the previous frame 449 and (ii) a ground truth indication of joint locations 442a and limb locations 442b for the previous frame 449. Further, the loss 452 may be calculated with the binary mask 453 masking out unlabeled regions in the frame 449. According to an embodiment, the loss 452 is calculated as described hereinabove in relation to equations 6 and 7.

The framework 440 is also used to calculate the temporal consistency loss 454. The temporal consistency loss 454 is the loss between (i) the joint location prediction results 445 and limb location prediction results 446 of the neural network 444 for a first frame 443 and (ii) joint location prediction results 450 and limb location prediction results 451 of the neural network 444 for a second frame 449, wherein the second frame 449 is adjacent to the first frame 443. In an embodiment, the temporal consistency loss 454 is calculated as described hereinabove in relation to equations 8 and 9.

In an embodiment, the losses 447, 454, and 452 are used in the framework 440 to update and train the neural network 444. These losses 447, 454, and 452 may be implemented in Equation 10 as described hereinbelow. The losses 447, 454, and 452 are indications of errors in estimating the joint and limb locations. By minimizing the losses 447, 454, and 452, via the optimization process during training the neural network 444, the network 444 is trained to be more accurate on estimating the location of human body joints and limbs. The optimization process is done by mathematically updating the neural network 444 by descending the gradient of the overall objective. More detail of training the network can be found below.

Overall Objectives

In an embodiment, there is an overall objective function of current prediction loss, reconstruction loss, and temporal consistency loss, to optimize the proposed video 2D pose estimation neural network, which is denoted as

$$ℒ = {ℒ}_{S} + {ℒ}_{L} + {λ}_{rec} ( {ℒ}_{Srec} + {ℒ}_{Lrec} ) + {λ}_{t e m p} ( {ℒ}_{S t e m p} + {ℒ}_{L t e m p} ) \qquad ( 10 )$$

where λ_{rec} and λₜₑₘₚ are hyper-parameters which control the relative weights of the reconstruction loss and temporal consistency loss in the overall objective function. In an example implemented, λ_{rec}=0.1 and λₜₑₘₚ=0.05.

Below is a method for training the neural network for video 2D multi-person pose estimation with multi-frame refinement:

Initialize network parameters θ_{G}
While θ_{G} has not converged d_{O}

Sample a pair of adjacent frames and keypoints {(Fᵢ, Pᵢ), (Fᵢ₋₁, Pᵢ₋₁)} from data distribution [symbol] _{data}(F, P);

Prepare ground-truth joints heatmaps S̅ᵢ and S̅ᵢ₋₁ and limbs maps L̅ᵢ and L̅ᵢ₋₁ using Pᵢ and Pᵢ₋₁;

Predict initial joints and limbs for both frames:

$${S}_{0 i}^{e s t} ← {G}_{S 0} ( {F}_{i} ) ;$$

$${L}_{0 i}^{e s t} ← {G}_{L 0} ( {F}_{i} ) ;$$

$${S}_{0 i - 1}^{e s t} ← {G}_{S 0} ( {F}_{i - 1} ) ;$$

$${L}_{0 i - 1}^{e s t} ← {G}_{L 0} ( {F}_{i - 1} ) ;$$

Refine current frame results using previous frame ground-truth:

$${S}_{i}^{e s t} ← {G}_{S R} ( {S}_{0 i}^{e s t} , {L}_{0 i}^{e s t} , {\overline{S}}_{i - 1} , {\overline{L}}_{i - 1} ) ;$$

$${L}_{i}^{e s t} ← {G}_{L R} ( {S}_{0 i}^{e s t} , {L}_{0 i}^{e s t} , {\overline{S}}_{i - 1} , {\overline{L}}_{i - 1} ) ;$$

Refine previous frame results using current frame ground-truth:

$${S}_{i - 1}^{e s t} ← {G}_{S R} ( {S}_{0 i - 1}^{est} , {L}_{0 i - 1}^{e s t} , {\overline{S}}_{i} , {\overline{L}}_{i} ) ;$$

$${L}_{i - 1}^{e s t} ← {G}_{L R} ( {S}_{0 i - 1}^{e s t} , {L}_{0 i - 1}^{e s t} , {\overline{S}}_{i} , {\overline{L}}_{i} ) ;$$

Reconstruct previous frame results using current frame prediction:

$${S}_{i - 1}^{rec} ← {G}_{S R} ( {S}_{0 i - 1}^{e s t} , {L}_{0 i - 1}^{e s t} , {S}_{i}^{e s t} , {L}_{i}^{e s t} ) ;$$

$${L}_{i - 1}^{rec} ← {G}_{L R} ( {S}_{0 i - 1}^{e s t} , {L}_{0 i - 1}^{e s t} , {S}_{i}^{e s t} , {L}_{i}^{e s t} ) ;$$

Calculate loss functions:

$${ℒ}_{S} ← {‖ {S}_{0 i}^{e s t} - {\overline{S}}_{i} ‖}_{2} + {‖ {S}_{i}^{e s t} - {\overline{S}}_{i} ‖}_{2} ;$$

$${ℒ}_{L} ← {‖ {L}_{0 i}^{e s t} - {\overline{L}}_{i} ‖}_{2} + {‖ {L}_{i}^{e s t} - {\overline{L}}_{i} ‖}_{2} ;$$

$${ℒ}_{Srec} ← {‖ {S}_{i - 1}^{rec} - {\overline{S}}_{i - 1} ‖}_{2} ;$$

$${ℒ}_{Lrec} ← {‖ {L}_{i - 1}^{rec} - {\overline{L}}_{i - 1} ‖}_{2} ;$$

$${ℒ}_{S t e m p} ← {‖ {S}_{i}^{e s t} - {S}_{i - 1}^{e s t} ‖}_{2} ;$$

$${ℒ}_{L t e m p} ← {‖ {L}_{i}^{e s t} - {L}_{i - 1}^{e s t} ‖}_{2} ;$$

Update G by descending its gradient:

$${∇}_{{θ}_{G}} {ℒ}_{s} + {ℒ}_{L} + {λ}_{rec} ( {ℒ}_{S r e c} + {ℒ}_{L r e c} ) + {λ}_{t e m p} ( {ℒ}_{S t e m p} + {ℒ}_{L t e m p} ) ;$$

### End

Output: Converged model parameter θ_{G}.

Training Method Embodiment

In the training phase, first, the data used for training the model is prepared. Then, a pair of adjacent frames with their ground-truth keypoints (Fᵢ, Pᵢ) and (Fᵢ₋₁, Pᵢ₋₁) are randomly sampled from the data distribution [symbol] _{data}(F, P). Fᵢ is of size (H×W×3), where H and W are the height of width of the frames. Pᵢ is of size mᵢ×p×2, where mᵢ is the number of people in the frame and p is the number of joints. For each type of joint, a Gaussian response is put in the joint heatmap Sᵢ for each person in Pᵢ. In turn, Sᵢ with size H×W×p is obtained. The limbs are defined as the region between joints of a width within a threshold E. For each limb region, such an embodiment fills each location with the limb direction denoted by a 2D normalized vector. Then, a limbs map of size H×W xx 2q is formed. Sᵢ and Lᵢ are downsampled to size H/4×W/4×p and H/4×W/4×2q using nearest neighbor. After preparing the input frames and ground truth joints heatmap and ground truth limbs heatmap, the variables are fed to the framework and the overall objectives [symbol] are calculated. The network G is continuously updated by descending the gradient of the [symbol] using new pairs of data sampled from [symbol] _{data}(F, P).

Network Architecture

Table 1 below shows an example network architecture of a proposed pose estimation neural network that may be used in an embodiment.

The example deep convolutional neural network comprises a backbone, and four submodules as shown in Table 1. In Table 1, N=Number of filters, K=Kernel size, S=Stride, P=Padding, RELU=Rectified Linear Units, MAXPOOL2d=Max pooling operation for spatial data, p=Number of joints, and q=Number of limbs.

TABLE 1
Neural Network Architecture

| | Shared Backbone | |
|---|---|---|
| 1 | CONV-(N64, K3, S1, P1, RELU) | |
| 2 | CONV-(N64, K3, S1, P1, RELU) | |
| 3 | MAXPOOL2d (K2, S2, P0) | |
| 4 | CONV-(N128, K3, S1, P1, RELU) | |
| 5 | CONV-(N128, K3, S1, P1, RELU) | |
| 6 | MAXPOOL2d (K2, S2, P0) | |
| 7 | CONV-(N256, K3, S1, P1, RELU) | |
| 8 | CONV-(N256, K3, S1, P1, RELU) | |
| 9 | CONV-(N256, K3, S1, P1, RELU) | |
| 10 | CONV-(N128, K3, S1, P1, RELU) | |
| | G_{S0} | G_{L0} |
| 11 | CONV-(N128, K7, S1, P3, RELU) | CONV-(N128, K7, S1, P3, RELU) |
| 12 | CONV-(N128, K7, S1, P3, RELU) | CONV-(N128, K7, S1, P3, RELU) |
| 13 | CONV-(N512, K7, S1, P3, RELU) | CONV-(N512, K7, S1, P3, RELU) |
| 14 | CONV-(Np, K1, S1, P0, RELU) | CONV-(N2q, K1, S1, P0, RELU) |
| | G_{SR} | G_{LR} |
| 15 | CONV-(N128, K7, S1, P3, RELU) | CONV-(N128, K7, S1, P3, RELU) |
| 16 | CONV-(N128, K7, S1, P3, RELU) | CONV-(N128, K7, S1, P3, RELU) |
| 17 | CONV-(N128, K7, S1, P3, RELU) | CONV-(N128, K7, S1, P3, RELU) |
| 18 | CONV-(N128, K7, S1, P3, RELU) | CONV-(N128, K7, S1, P3, RELU) |
| 19 | CONV-(N512, K7, S1, P3, RELU) | CONV-(N512, K7, S1, P3, RELU) |
| 20 | CONV-(Np, K1, S1, P0, RELU) | CONV-(N2q, K1, S1, P0, RELU) |

The backbone is a VGG [13] style neural network used to extract pretrained features from a given frame. In an embodiment, the backbone is pretrained on ImageNet dataset [4] and fine-tuned in a pose estimation application. In the backbone, the input frame is downsampled twice with the MAXPOOL2d layer which reduces the height and width by 4 times when outputting the joints heatmap and limb heatmap. The backbone network is followed by a initial joint prediction submodule G_{S0} and a initial limb prediction module G_{L0}, which take the output of the backbone as their inputs and predict their results. After that, the prediction results are refined by the two refinement submodules G_{SR} and G_{LR}, which utilize multi-frame refinement to improve the accuracy and consistency of the prediction results. Embodiments provide a neural network that is lightweight and runs quickly on devices, such as GPU enabled devices. To further speed up operation, in an embodiment, the convolutional layers can be replaced by a pair of equivalent depthwise convolution layers and pointwise convolution layers such as the architecture proposed in MobileNet[8].

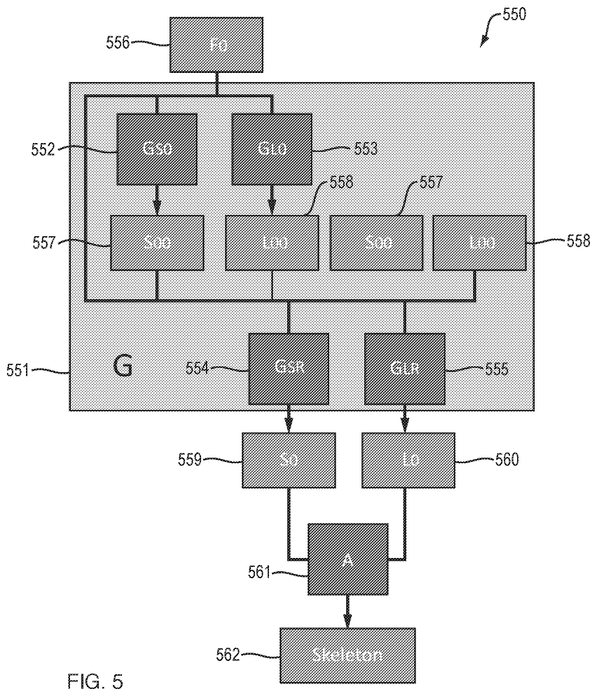

FIG. 5 is a block diagram of a system embodiment for identifying joints and limbs for a first frame of video. In the system 550, the identification of limbs and joints is made by the neural network 551 that includes the subnetworks 552, 553, 554, and 555, for a first frame of video 556.

In operation G 551 takes the current frame 556 as input and does an initial estimation using the submodules 552 and 553 to determine a joint heatmap 557 and a limb heatmap 558. In turn, the initial estimations 557 and 558 are refined by the submodule 554 and submodule 555 using the initial estimations themselves, 557 and 558. The refining by the submodules 554 and 555 produces 559 and 560, which are the estimation of the joint heatmap and limb heatmap of the frame 556. In this way, the system 550 implements self-refinement. In the framework 550, the submodules 552, 553, 554, and 555 are all deep convolutional neural networks.

The system 550 continues, and using the pose association module 561, constructs the one or more skeletons 562 in the frame 556 using both the joint prediction 559 and limb prediction 560. An embodiment may use pose association methods known in the art to assemble joints and limbs into skeletons.

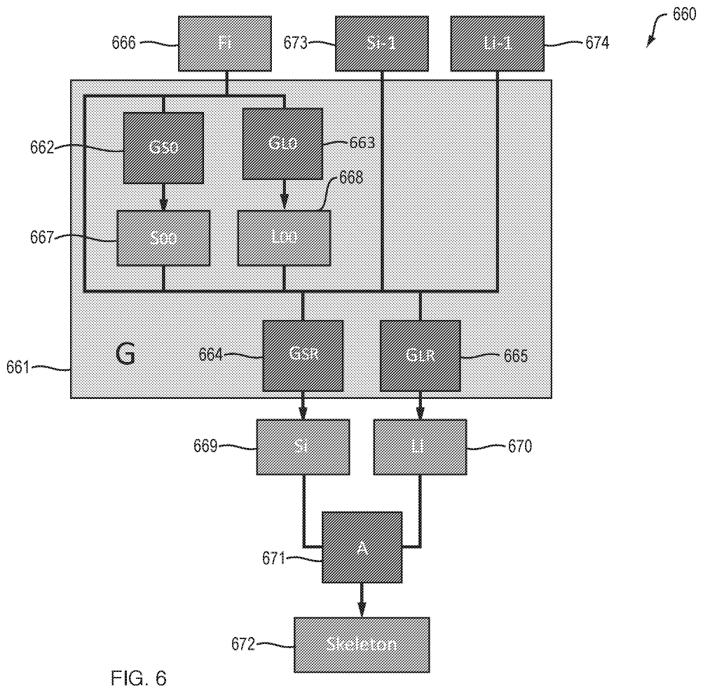

FIG. 6 is a block diagram of a system embodiment 660 for identifying joints and limbs using identification results from a previous frame. In the system 660, the identification of limbs and joints is made by the neural network 661 that includes the subnetworks 662, 663, 664, and 665, for a frame of video 666.

In operation G 661 takes the current frame 666 as input and does an initial estimation using the submodule 662 and submodule 663 to determine a joint heatmap 667 and a limb heatmap 668. In turn, the initial estimations 667 and 668 are refined by the submodule 664 and submodule 665 using the joint estimation 673, i.e., heatmap, and limb estimation 674 from a previous frame of video. The refining by the submodules 664 and 665 produces the estimation of the joints heatmap 669 and the estimation of the limbs heatmap 670 for the frame 666. In this way, the system 660 refines the current estimation results 667 and 668 using the results 673 and 674 from a previous frame. In an embodiment, the refinement is done by the trained network 661 which includes the submodules 662, 663, 664, and 665. This refinement can handle difficult cases in video pose estimation such as motion blur and occlusion. The refinement can also improve the shaking and vibration of estimated results. In the framework 660, the submodules 662, 663, 664, and 665 are all deep convolutional neural networks.

The system 660 continues, and using the pose association module 671, constructs the one or more skeletons 672 in the frame 666 using both the joint prediction 669 and limb prediction 670.

Embodiments provide a novel deep learning model particularly optimized for video 2D multi-person pose estimation applications. Embodiments introduce multi-frame refinement and optimization to the bottom up pose estimation method. The multi-frame refinement and optimization includes a novel method of tracking, backward reconstruction, and temporal consistency. Multi-frame refinement enables the pose estimation model to track poses and handle occlusions. Backward reconstruction and temporal consistency minimize inconsistent detection, which mitigates the shaking and vibration and improves the robustness in video pose estimation applications.

Using multi-frame refinement as described herein can be considered as an equivalent process to tracking. Tracking is a method to refine results by considering the temporal movement of objects in the video. Traditionally, approaches use the final output results of pose estimation to do tracking based on statistic assumptions. Tracking methods often stabilize the estimation results and improve the accuracy. Embodiments train the neural network to learn the movement of human bodies by feeding the neural network with previous frames. Then, the neural network can track the poses from previous frames and estimate the current poses more accurately even under occlusions. Embodiments can also enforce temporal consistency between adjacent frames to stabilize the results. As such, embodiments can provide tracking by multi-frame refinement.

Embodiments tackle a video-based multi-person pose estimation problem using a deep learning framework with multi-frame refinement and optimization. In a particular embodiment, a method inherently tracks estimated poses and makes a model insensitive to occlusions. The method may employ a backward reconstruction loop and temporal consistency to an objective function that mitigates inter-frame inconsistency and significantly reduces shaking and vibration phenomena of estimated pose skeletons in video pose estimation.

An embodiment of the invention utilizes pose estimation results of previous frames to refine a current frame result to track poses and handle occlusions. An embodiment of the invention applies a backward loop to reconstruct a previous pose estimation from a current frame to improve robustness and minimize inconsistent estimation. An embodiment of the invention introduces a temporal consistency loss that penalizes on temporal changes in detection between adjacent frames to avoid shaking and vibration in video pose estimation.

Embodiments generate a more accurate and robust pose estimation than existing methods. An embodiment tracks multi-person human poses in videos and handles occlusions. Embodiments output pose estimation with temporal consistency across frames, which avoids shaking and vibration in video pose estimation. Embodiments are computationally less expensive compared to the other pose estimation methods which require extra tracking modules.

Embodiments can be applied in detecting human behaviors in monitoring systems. Embodiments can be applied in video games to use human body movement as input, such as Xbox® Kinect®. Embodiments can be applied in many interesting mobile apps that require human body movement as input such as personal fitting and training.

Video-based multi-person pose estimation often involves tracking methods to improve estimation accuracy by utilizing temporal information in videos. The tracking methods track a detected person across adjacent frames and then track key points of that person to avoid failure detection due to motion blur and occlusions. Those tracking methods cannot be applied on bottom-up methods since bottom-up methods do not provide any knowledge of the person in each frame. Tracking the person's joints (e.g., elbows shoulders, knees) without knowing the movement of the person leads to unsatisfactory results. In video applications, pose estimation is applied frame by frame, which leads to inconsistent pose estimation across adjacent frames. The inconsistency causes problems, like shaking and jumping of key point detection.

To solve the above problems, an embodiment of the invention of video multi-person pose estimation provides a state-of-the-art image-based bottom-up method that is specially optimized for a video application to solve the inconsistent detection between adjacent frames. To utilize the temporal information contained in the video and avoid inconsistent detection across frames, a previous frame is used to refine a pose estimation result of a current frame. An embodiment tracks the person's poses across frames to handle occlusions. Another embodiment builds a backward path and reconstructs a previous pose estimation refined by a current estimation and penalizes on inconsistency between adjacent pose estimation. Moreover, assuming the movement between two adjacent frames is minor, an embodiment also penalizes based on a difference between the estimation on a previous frame and the estimation on a current frame to stabilize the pose estimation and alleviate shaking and vibration of the estimated poses in videos. With the above techniques, embodiments establish a robust and stable multi-person pose estimation which can be deployed on many applications that require human pose input.

In an embodiment, the input joints location are results from the previous frame. The neural network takes the estimation from the previous frame to help estimate the joints location of the current frame. The refined results here are referred to results of the current frame. By comparing the results with the ground-truth location an embodiment can update the network to correctly predict the joints locations of current frames.

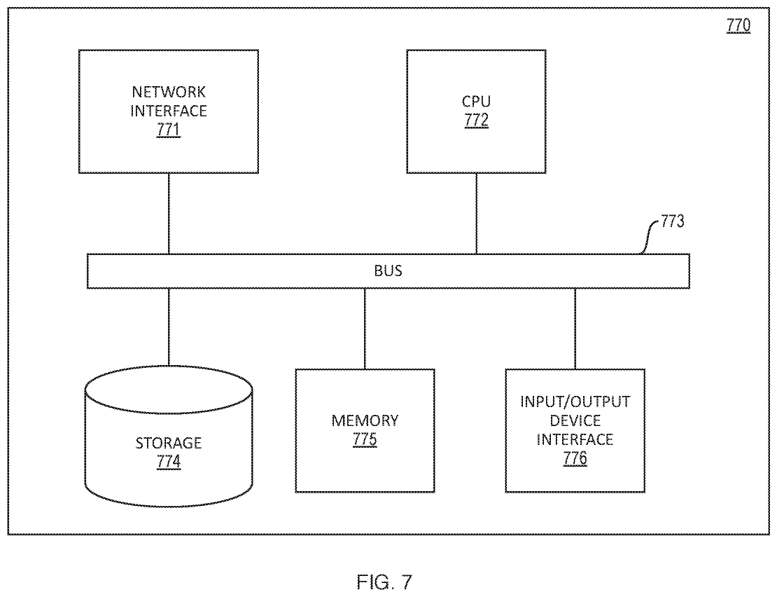

FIG. 7 is a simplified block diagram of a computer-based system 770 that may be used to implement any variety of the embodiments of the present invention described herein. The system 770 comprises a bus 773. The bus 773 serves as an interconnect between the various components of the system 770. Connected to the bus 773 is an input/output device interface 776 for connecting various input and output devices such as a keyboard, mouse, display, speakers, etc. to the system 770. A central processing unit (CPU) 772 is connected to the bus 773 and provides for the execution of computer instructions implementing embodiments. Memory 775 provides volatile storage for data used for carrying out computer instructions implementing embodiments described herein, such as those embodiments previously described hereinabove. Storage 774 provides non-volatile storage for software instructions, such as an operating system (not shown) and embodiment configurations, etc. The system 770 also comprises a network interface 771 for connecting to any variety of networks known in the art, including wide area networks (WANs) and local area networks (LANs).

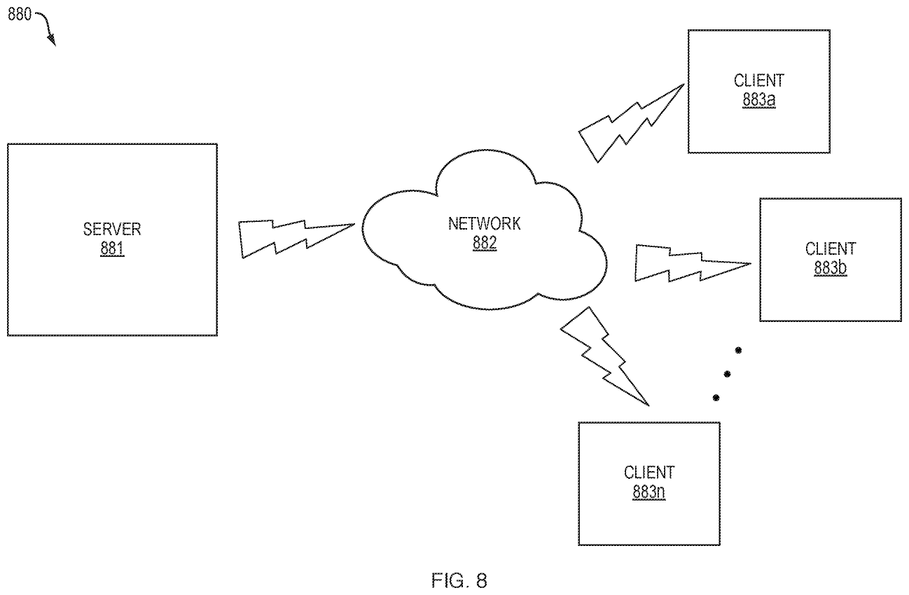

It should be understood that the example embodiments described herein may be implemented in many different ways. In some instances, the various methods and systems described herein may each be implemented by a physical, virtual, or hybrid general purpose computer, such as the computer system 770, or a computer network environment such as the computer environment 880, described herein below in relation to FIG. 8. The computer system 770 may be transformed into the systems that execute the methods described herein, for example, by loading software instructions into either memory 775 or non-volatile storage 774 for execution by the CPU 772. One of ordinary skill in the art should further understand that the system 770 and its various components may be configured to carry out any embodiments or combination of embodiments of the present invention described herein. Further, the system 770 may implement the various embodiments described herein utilizing any combination of hardware, software, and firmware modules operatively coupled, internally, or externally, to the system 770.

FIG. 8 illustrates a computer network environment 880 in which an embodiment of the present invention may be implemented. In the computer network environment 880, the server 881 is linked through the communications network 882 to the clients 883a-n. The environment 880 may be used to allow the clients 883a-n, alone or in combination with the server 881, to execute any of the embodiments described herein. For non-limiting example, computer network environment 880 provides cloud computing embodiments, software as a service (SAAS) embodiments, and the like.

Embodiments or aspects thereof may be implemented in the form of hardware, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus, the data processors described herein are intended for purposes of illustration only and not as a limitation of the embodiments.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

### REFERENCES

[1] M. Andriluka, S. Roth, and B. Schiele. Pictorial structures revisited: People detection and articulated pose estimation. In Computer Vision and Pattern Recognition, 2009. CVPR 2009. IEEE Conference on, pages 1014-1021. IEEE, 2009.
[2] Z. Cao, T. Simon, S.-E. Wei, and Y. Sheikh. Realtime multi-person 2d pose estimation using part affinity fields. In Proceedings of the IEEE Conference on Computer Vision and Pattern Recognition, pages 7291-7299, 2017.
[3] X. Chen and A. L. Yuille. Articulated pose estimation by a graphical model with image dependent pairwise relations. In Advances in neural information processing systems, pages 1736-1744, 2014.
[4] J. Deng, W. Dong, R. Socher, L.-J. Li, K. Li, and L. Fei-Fei. ImageNet: A Large-Scale Hierarchical Image Database. In CVPR09, 2009.
[5] H. Fang, S. Xie, Y.-W. Tai, and C. Lu. Rmpe: Regional multi-person pose estimation. In The IEEE International Conference on Computer Vision (ICCV), volume 2, 2017.
[6] G. Gkioxari, P. Arbeláez, L. Bourdev, and J. Malik. Articulated pose estimation using discriminative armlet classifiers. In Computer Vision and Pattern Recognition (CVPR), 2013 IEEE Conference on, pages 3342-3349. IEEE, 2013.
[7] K. He, G. Gkioxari, P. Dollár, and R. Girshick. Mask r-cnn. In Computer Vision (ICCV), 2017 IEEE International Conference on, pages 2980-2988. IEEE, 2017.
[8] A. G. Howard, M. Zhu, B. Chen, D. Kalenichenko, W. Wang, T. Weyand, M. Andreetto, and H. Adam. Mobilenets: Efficient convolutional neural networks for mobile vision applications. arXiv preprint arXiv: 1704.04861, 2017.
[9] S. Johnson and M. Everingham. Learning effective human pose estimation from inaccurate annotation. In Computer vision and pattern recognition (CVPR), 2011 IEEE conference on, pages 1465-1472. IEEE, 2011.
[10] A. Newell, Z. Huang, and J. Deng. Associative embedding: End-to-end learning for joint detection and grouping. In Advances in Neural Information Processing Systems, pages 2274-2284, 2017.
[11] G. Papandreou, T. Zhu, N. Kanazawa, A. Toshev, J. Tompson, C. Bregler, and K. Murphy. Towards accurate multi-person pose estimation in the wild. In Proceedings of the IEEE Conference on Computer Vision and Pattern Recognition, pages 4903-4911, 2017.
[12] L. Pishchulin, E. Insafutdinov, S. Tang, B. Andres, M. Andriluka, P. V. Gehler, and B. Schiele. Deepcut: Joint subset partition and labeling for multi person pose estimation. In Proceedings of the IEEE Conference on Computer Vision and Pattern Recognition, pages 4929-4937, 2016.
[13] K. Simonyan and A. Zisserman. Very deep convolutional networks for large-scale image recognition. arXiv preprint arXiv: 1409.1556, 2014.
[14] Y. Yang and D. Ramanan. Articulated pose estimation with flexible mixtures-of-parts. In Computer Vision and Pattern Recognition (CVPR), 2011 IEEE Conference on, pages 1385-1392. IEEE, 2011.

What is claimed is:

1. A method of identifying joints and limbs in a current frame of video, the method comprising:
processing the current frame of video to determine initial predictions of joint and limb locations in the current frame; and
generating indications of the joint and limb locations in the current frame by refining the initial predictions of the joint and limb locations based on indications of respective joint and limb locations from a previous frame.

2. The method of claim 1 further comprising:
generating an indication of pose for at least one object based upon the indications of the joint and limb locations in the current frame.

3. The method of claim 1 wherein the indications of the joint and limb locations in the current frame correspond to joints and limbs of at least one of: a human, animal, machine, and robot.

4. The method of claim 1 wherein generating the indications of the joint and limb locations in the current frame comprises:
processing the initial prediction of joint locations in the current frame and the indications of joint locations from the previous frame with a first deep convolutional neural network to generate the indication of joint locations in the current frame; and
processing the initial prediction of limb locations in the current frame and the indications of limb locations from the previous frame with a second deep convolutional neural network to generate the indication of limb locations in the current frame.

5. The method of claim 1 wherein:
the indication of joint locations in the current frame indicates a probability of a joint at each location in the current frame; and
the indication of limb locations in the current frame indicates a probability of a limb at each location in the current frame.

6. The method of claim 1 further comprising:
processing the current frame of video to determine an initial prediction of limb orientation at each initial prediction of limb location in the current frame; and
generating an indication of limb orientation in the current frame by refining the initial prediction of limb orientation at each initial prediction of limb location in the current frame using indications of limb orientations from the previous frame.

7. The method of claim 1 wherein the previous frame is adjacent in time to the current frame in the video.

8. A computer system for identifying joints and limbs in a current frame of video, the computer system comprising:
a processor; and
a memory with computer code instructions stored thereon, the processor and the memory, with the computer code instructions, being configured to cause the system to:
process the current frame of video to determine initial predictions of joint and limb locations in the current frame; and
generate indications of the joint and limb locations in the current frame by refining the initial predictions of the joint and limb locations based on indications of respective joint and limb locations from a previous frame.

9. The system of claim 8 wherein the processor and the memory, with the computer code instructions, are further configured to cause the system to:
generate an indication of pose for at least one object based upon the indications of the joint and limb locations in the current frame.

10. The system of claim 8 wherein the indications of joint and limb locations in the current frame correspond to joints and limbs of at least one of:
a human, animal, machine, and robot.

11. The system of claim 8 wherein, in generating the indications of the joint and limb locations in the current frame, the processor and the memory, with the computer code instructions, are configured to cause the system to:
process the initial prediction of joint locations in the current frame and the indications of joint locations from the previous frame with a first deep convolutional neural network to generate the indication of joint locations in the current frame; and
process the initial prediction of limb locations in the current frame and the indications of limb locations from the previous frame with a second deep convolutional neural network to generate the indication of limb locations in the current frame.

12. The system of claim 8 wherein:
the indication of joint locations in the current frame indicates a probability of a joint at each location in the current frame; and
the indication of limb locations in the current frame indicates a probability of a limb at each location in the current frame.

13. The system of claim 8 wherein the processor and the memory, with the computer code instructions, are further configured to cause the system to:
process the current frame of video to determine an initial prediction of limb orientation at each initial prediction of limb location in the current frame; and
generate an indication of limb orientation in the current frame by refining the initial prediction of limb orientation at each initial prediction of limb location in the current frame using indications of limb orientations from the previous frame.

14. The system of claim 8 wherein the previous frame is adjacent in time to the current frame in the video.

15. A computer program product for identifying joints and limbs in a current frame of video, the computer program product comprising:
one or more non-transitory computer-readable storage devices and program instructions stored on at least one of the one or more storage devices, the program instructions, when loaded and executed by a processor, cause an apparatus associated with the processor to:
process the current frame of video to determine initial predictions of joint and limb locations in the current frame; and
generate indications of the joint and limb locations in the current frame by refining the initial predictions of the joint and limb locations based on indications of respective joint and limb locations from a previous frame.

16. The computer program product of claim 15 wherein the program instructions, when loaded and executed by the processor, further cause the apparatus associated with the processor to:
process the current frame of video to determine an initial prediction of limb orientation at each initial prediction of limb location in the current frame; and
generate an indication of limb orientation in the current frame by refining the initial prediction of limb orientation at each initial prediction of limb location in the current frame using indications of limb orientations from the previous frame.

17. A method of training a neural network to identify joints and limbs in a current frame of video, the method comprising:
performing forward and backward optimization between adjacent frames of video to refine joint location prediction results and limb location prediction results of a neural network; and
updating the neural network based on the refined joint location prediction results and the refined limb location prediction results.

18. The method of claim 17 wherein performing the forward optimization comprises:
calculating a loss between (i) joint location prediction results and limb location prediction results generated by the neural network for a frame of video and (ii) a ground truth indication of joint locations and limb locations in the frame of video.

19. The method of claim 17 wherein performing the backward optimization comprises:
processing, with the neural network, (i) joint location prediction results generated by the neural network for a frame of video, (ii) limb location prediction results generated by the neural network for the frame of video, and (iii) a previous frame to determine an indication of joint locations and an indication of limb locations for the previous frame; and
calculating a loss between (i) the determined indication of joint locations and the determined indication of limb locations for the previous frame and (ii) a ground truth indication of joint locations and limb locations for the previous frame.

20. The method of claim 17 wherein performing forward and backward optimization between adjacent frames of video to refine joint location prediction results and limb location prediction results of the neural network comprises:
calculating a temporal consistency loss by calculating a loss between (i) joint location prediction results and limb location prediction results of the neural network for a first frame and (ii) joint location prediction results and limb location prediction results of the neural network for a second frame, wherein the second frame is adjacent to the first frame.
